(19) United States
(12) Patent Application Publication
(10) Pub. No.: US 2011/0132373 A1
(43) Pub. Date: Jun. 9, 2011

(54) Biohazard Mask Filter

(75) Inventor: David R. Freriks, Hinckley, IL (US)

(73) Assignee: LINCOLN ADVANCED TECHNOLOGIES, LLC, HINCKLEY, IL (US)

(21) Appl. No.: 13/025,376

(22) Filed: Feb. 11, 2011

Related U.S. Application Data
(63) Continuation of application No. 10/861,231, filed on Jun. 3, 2004, now abandoned.
Application No. 10/861,231 is a continuation-in-part of application No. 10/459,417, filed on Jun. 11, 2003, now Pat. No. 7,152,600.

(51) Int. Cl. A62B 19/00; B01D 46/00

(52) U.S. Cl. 128/206.17; 55/486

(57) ABSTRACT

An exhalate filter medium for a biohazard mask is made of polytetrafluoroethylene (PTFE) and surrounding layers of a wicking material and an antimicrobial material. The exhalate filter may be contained in a removable and replaceable cartridge snap-fit into the surface of a biohazard mask.

### RELATED APPLICATIONS

This application is a continuation-in-part, claiming priority to application Ser. No. 10/459,417, filed Jun. 11, 2003, “BIOHAZARD MASK SUITABLE FOR CIVILIANS.” The disclosure of the '417 application is incorporated herein by reference.

### FIELD OF THE INVENTION

This invention relates o filter media for masks which protect against biological hazards.

### BACKGROUND OF THE INVENTION

Recent developments in antimicrobial respirators have taken the approach of filtering exhaled breath as well as inhaled breath (U.S. Pat. No. 6,584,976 B2, issued to Japuntich et al.; '417 application, filed by Freriks et al.; both incorporated herein by reference). By filtering exhalation, the wearer is prevented from exhaling both biologic entities such as bacteria and viruses into the environment where they can contaminate their surroundings and infect other people. Also, they are prevented from exhaling particles which would disturb or contaminate environments that are intended to be particularly clean such as pharmaceutical or nanotechnology production facilities.

Unfortunately, there would be problems to overcome with this approach to filtering. In particular, the filtering of exhalation would likely result in moisture build up in the filter media making the pressure drop (resistance) to exhalation extremely high and making respiration difficult. This would result in frequent changes of respirators or filters and exposing wearer's and others to unwanted contamination. This is particularly true if the filter media is comprised of typical HEPA filtering material comprised of non-woven fibers. These media would become saturated with water vapor from the wearers' exhalation and would have to be changed on a frequent basis.

It is desirable therefore to have an exhalation filter unit for respirators or masks which could maintain low pressure drop, (i.e., low exhalation resistance) and superior moisture vapor transmission rate while trapping bacteria and viruses in the interior of the filter.

Modern membrane technologies have resulted in HERA level filtration characteristics with very low resistance, but none has been designed specifically for the filtering of human exhalation or use in respirators which accomplish this purpose. Developments in membrane technology by Gore and others (e.g., U.S. Pat. No. 4,187,390, incorporated herein by reference) have shown that extremely high rates of moisture vapor transmission can be achieved using modern membrane manufacturing technologies. However, this moisture vapor transmission (MVT) capability has not been integrated with HERA (High Efficiency Particulate filtration) level filtration related to antimicrobial filtration, particularly with regard to the filtering of human exhalation until the present invention.

Processes for making porous PTFE membranes having customized and uniform pore size are known (e.g., U.S. Pat. No. 5,910,277 to Ishino et al., incorporated herein by reference), as are inhalation filter units employing PTFE membranes (e.g., U.S. Pat. No. 6,309,438, to Kanno et al.). Missing in the art is the use of PTFE membranes which meet the specialized requirements for exhalation filters, namely, HEPA level filtration of bacterial and viral matter, coupled with low pressure drop and high MVT.

The filter material itself is not the only feature of a filter unit requiring special design consideration for exhalation. The physical structure of an exhalation filter also requires attention. In a biohazard mask suitable for civilian use (or any other mask requiring filtering), the filter unit structure should be easily replaceable, with minimum discomfort to the user during replacement but maximum safety during quarantine conditions.

### SUMMARY OF THE INVENTION

The present invention accommodates the above-mentioned goals through a number of design features, appearing as recited in various instances and combinations in the appended claims. Generally the present invention relates to a filter wherein the moisture vapor transmission efficiency has been improved by using a porous PTFE film with a specific pore diameter. The moisture vapor transmission can also be improved by the use of coatings or layers that enhance either or both of the wicking and evaporative qualities of the PTFE material, or the anti-biologic and anti-viral properties of the filter (e.g., using biocidal materials).

The present invention also contemplates, in another embodiment, a pair of horseshoe shaped filter cartridges, just below the nose portion of the mask. These cartridges rest inset into the surface of the mask, but external to the valve assembly (which is integral to the mask). One horseshoe-shaped filter cartridge is for inhalation, and one for exhalation. The cartridges are snap-fit (in any manner known in the art), and can be ejected (popped out) by pushing a button, or any other suitable mechanical actuator.

### DETAILED DESCRIPTION OF THE PREFERRED EMBODIMENTS

One embodiment (embodiment 1) of the present invention is a polytetrafluoroethylene porous film between two layers of nonwoven polyolefin spun bond which is impregnated with antimicrobial chemicals on the interior side of the filtering element. The purpose of the antimicrobial additives is to provide a lethal environment for biologics trapped in the media. Hence, this embodiment involves three layers. The middle layer is PTFE. This is sandwiched by layers of spun bond, known in the art to give rigidity to the PTFE membrane. On the layer intended to be on the face-side of the mask (for exhalate) or the ambient side of the mask (for inhalate), an antimicrobial chemical is added in sufficient effective doses, for example, an agent like REPUTEX which works within the spunbond material to control the growth of microbes. In this embodiment and all of the others herein, the PTFE pore size is preferable 0.1 to 0.4 microns, and most preferably 0.2 microns, in order to allow maximum transmission of water vapor, with minimum chance for passage of bacterial or viral matter.

Another embodiment (embodiment 2) involves the same three layer structure as embodiment 1, but instead of antimicrobial coatings, there is added a wicking material to the spun bond on the ambient side of the exhalation filter. Such wicking materials may include the DP-988 Synthetic-Fiber Hydrophilic Finishing Agent, manufactured by Zhangjiagang Duplus Chemical Co., or similar chemicals manufactured by Daiwa Corporation, Japan. These chemicals have the effect of improving the transmissivity of water vapor away from the filter unit.

Another embodiment (embodiment 3) involves combining embodiments 1 and 2 into a single exhalation filter, in which one side of the membrane has spun bond impregnated with a wicking material, and the other side of the membrane has spun bond impregnated with an antimicrobial material.

Another embodiment (embodiment 4) involves a four-or-five layer filter medium according to the respective teachings of embodiments 1 through 3. In this embodiment, one or more of the spun bond layers sandwiching the PTFE membrane may be inert/uncoated. The various wicking and antimicrobial functions described with respect to embodiments 1 through 3 would be accomplished by adding an entirely new layer, as desired. For example, there may be a five layer filter medium for an exhalation filter with the top layer (exposed to the ambient) containing the wicking material, the layer below that spun bond, the layer below that a PTFE membrane, the layer below that another spun bond layer, and finally the bottom layer (exposed to the wearer's exhalate) containing the antimicrobial material, These additional layers may themselves be a base of spun bond, or may be any other material suitable for holding the applicable chemicals while exhibiting low pressure drop to easily pass breath.

All of the foregoing embodiments may be included in a filter cartridge structure designed for easy replaceability. Preferably, the filter cartridge is in the shape of a horseshoe, and has an internal volume (about 1½ inches thick) containing the appropriate filter medium. The exterior surface of the cartridge includes a grill. The cartridges sit on the surface of the mask, just under the nose portion. One is for inhalation, and is removably seated on the mask. One is for exhalation, and is removably seated on the mask. The seating is preferably a snap-fit, where buttons on the mask will permit pop-out removal of each respective filter cartridge. Other mechanical actuators are also contemplated, e.g., catch releases, slides, etc.

Pop-out ejection of filter cartridges, coupled with snap-fit insertions, permit quick changes. This can be important during quarantine conditions, both for comfort and for the safety of self and others.

It will be appreciated that those skilled in the art may now make many uses and modifications of the specific embodiments described without departing from the inventive concepts. The recitation of the features and characteristics of the embodiments shown above is not meant to be limiting, but rather exemplary, with the appended claims and their equivalents defining the patentee's property rights hereunder.

1-5. (canceled)

6. An exhalation filter medium having an ambient side and a face side, the medium comprising:
(a) a PTFE layer,
(b) a first nonwoven polyolefin spun bond layer positioned on the PTFE layer on the ambient side of the medium and including a wicking material;
(c) a second nonwoven polyolefin spun bond layer positioned on the PTFE layer on the face side of the medium and the layer being impregnated with an antimicrobial material; and
(d) a third nonwoven and uncoated polyolefin layer positioned between the first layer and the PTFE layer or positioned between the second layer and the PTFE layer.

7. The filter medium of claim 6 further comprising a third nonwoven polyolefin layer positioned between the second layer and the PTFE layer and attached to both layers.

8. The filter medium of claim 7 further comprising a fourth nonwoven polyolefin layer positioned between the first layer and the PTFE layer and attached to both layers.

9. The filter medium of claim 8 wherein the fourth layer is inert.

10. The filter medium of claim 6, wherein the PTFE layer has pore sizes within a range of 0.1-0.4 microns.

11. The filter medium of claim 6, wherein the PTFE layer has pore sizes of 0.2 microns.

12. A biohazard mask including separate inhalation and exhalation filters, the biohazard mask comprising:
a plurality of receptacles for the holding at least a first filter cartridge containing an inhalation filter and a second filter cartridge containing an exhalation filter;
the exhalation filter comprising:
(a) a PTFE layer;
(b) a first nonwoven polyolefin spun bond layer positioned on the PTFE layer and including a wicking material;
(c) a second nonwoven polyolefin spun bond layer positioned on the PTFE layer and being impregnated with an antimicrobial material; and
(d) a third nonwoven and uncoated polyolefin layer positioned between the first layer and the PTFE layer or positioned between the second layer and the PTFE layer.

13. The biohazard mask of claim 12, wherein the PTFE layer has a pore size within the range of 0.1-0.4 microns.

14. The biohazard mask of claim 13, wherein the PTFE layer has a pore size of 0.2 microns.
